(19) United States
(12) Patent Application Publication
(10) Pub. No.: US 2017/0021658 A1
(43) Pub. Date: Jan. 26, 2017

(54) Hands Free Music Sheet Turner

(71) Applicant: Joshua Robert Dunbar, Ellicott City, MD (US)

(72) Inventor: Joshua Robert Dunbar, Ellicott City, MD (US)

(21) Appl. No.: 14/805,734

(22) Filed: Jul. 22, 2015

(51) Int. Cl. B42D 9/06

(52) U.S. Cl. CPC B42D 9/06

(57) ABSTRACT

The Hands Free Music Sheet Turner will allow a musician to flip a page of music by means of a mechanical foot pedal. Thus removing the need for having to flip the sheets with his/her hand and allowing the flow of music to be uninterrupted.

### BACKGROUND OF THE INVENTION

Nearly all musical instruments require two hands to play. When you are practicing or playing at a show and using a music stand it is difficult to change the page without breaking the rhythm/flow of the song. This is because you need to remove your hand from the instrument (and thus stop playing) then grab the page and flip it and finally get your hand back to the correct position on your instrument. During this time musicians rush because they do not want a large break of music in their performance, this rush can likely lead to mistakes upon the return of the positioning of your hand. The current music stand requires a pause in the playing of an instrument in order to change the page.

### BRIEF SUMMERY OF INVENTION

By using a simple mechanical foot pedal with no electronic components a swinging magnetic arm is activated and the Hands Free Music Sheet Turner grabs a sheet of paper that is enclosed in a laminated cover allowing the musician to change the page of music without removing their hands from the instrument. This keeps the flow and rhythm which are vital components to a musical performance. This invention also lessens the stress of the musician by removing the worry of having to rush and break the music's flow.

### BRIEF DESCRIPTION OF DRAWINGS

FIG. 1 shows the full front view of the stand including all its components.

1.1 Depicts the traditional three ring binder clamps in the center of the stand.

1.2 A piece of metal in the bottom right of the clear sleeve that will allow the magnetic arm to grab the paper/

1.3 The Release tab that will open the ring clasps in order to add/remove music sheets.

1.4 The horizontal metal arm with a magnet at the end

1.5 Guide tracks that will create the swinging motion of the horizontal metal arm/magnet/

1.6 A foot pedal connected by a chain to the inner shaft of the stand.

FIG. 2A is a top section view of the inside of the shaft.

2A.1 Is the outer frame of the music stand.

2A.2 The inner shaft of the music stand which will be sliding up and down as well as swinging left to right.

2A.3 This is a section of where the guide track for the horizontal metal arm is cut out of the main shaft.

2A.4 The horizontal metal arm.

2A.5 The magnet.

FIG. 2B is a side view of FIG. 2A

2B.1 Is the outer frame of the music stand.

2B.2 The inner shaft of the music stand which will be sliding up and down as well as swinging left to right.

2B.3 This is a section of where the guide track for the horizontal metal arm is cut out of the main shaft.

2B.4 The horizontal metal arm.

2B.5 The magnet.

FIG. 3 Is a side section view of the bottom of the music stands inner workings and foot pedal.

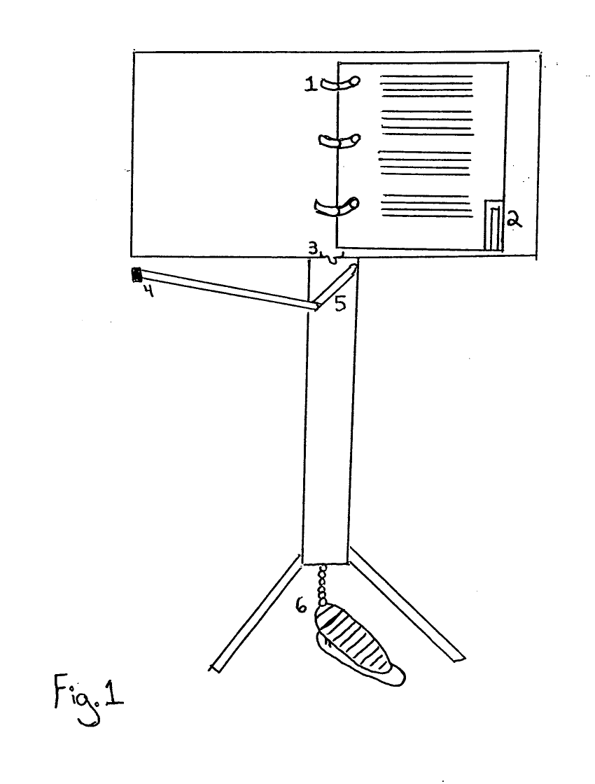

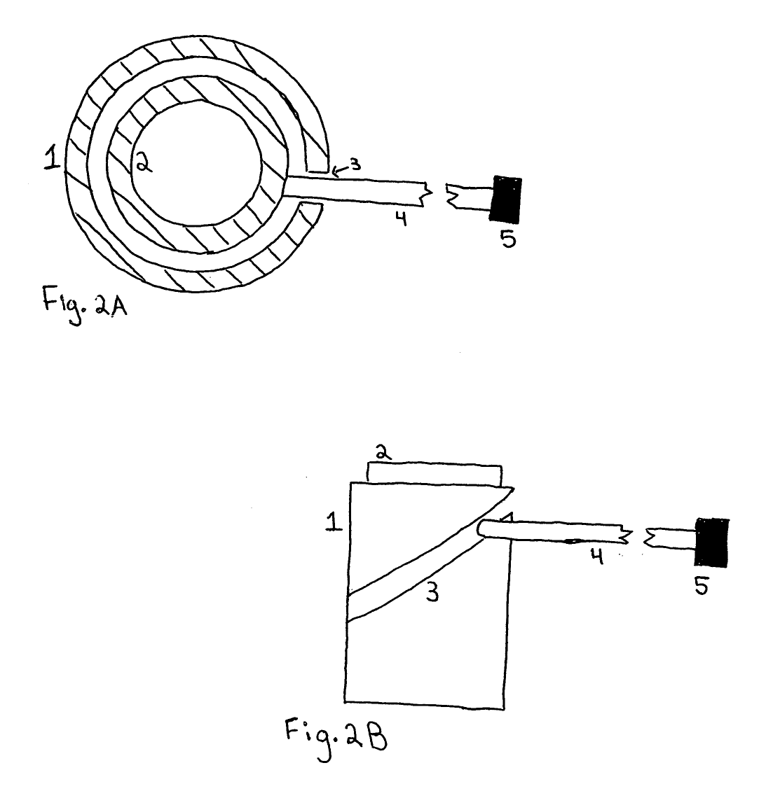

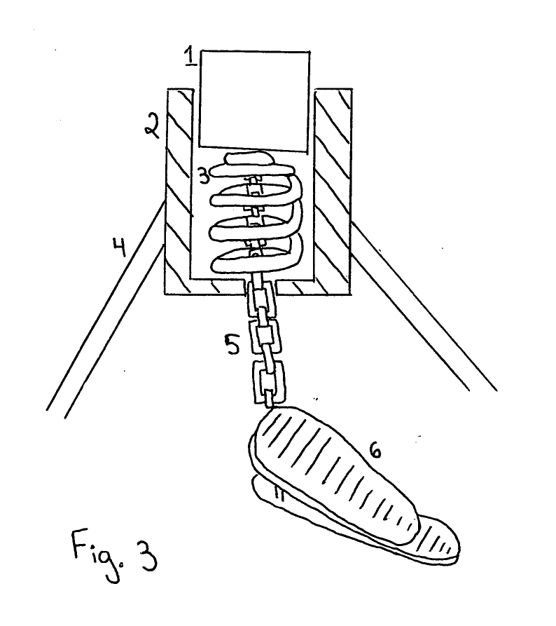

3.1 The inner shaft that will move up and down and swing left to right.

3.2 The outer shaft.

3.3 A spring inside that will push the inner shaft up, and thus swing the arm back from the left to the right, after the foot pedal is released from being pressed down.

3.4 A leg to hold the music stand up

3.5 Chain that connects the foot pedal to the inner shaft.

3.6 The foot pedal.

### DETAILED DESCRIPTION OF THE INVENTION

The Hands Free Music Sheet Turner is non-electrical and fully mechanical operated by a series of simple machines first started with the foot pedal. When the musician presses down on the pedal a vertical bar that's inside the stands frame slides down. There is a protruding horizontal metal arm that is attached perpendicular to the sliding vertical bar and when they slide down together the metal arm is guided by tracks to make a swinging motion from right to left. At the end of the metal arm is a magnet that will grab the individual pages. Each page will be in a clear laminated sleeve with a slim piece of metal on the bottom right, the left side of the sleeve will have the traditional 3 hole punches and will be clipped into the center of the music stand using three built in binder clips. The magnet on the metal arm will connect to the sleeves metal strip in the bottom right of the page. When the pedal is pressed down the arm will begin to swing from right to left thus flipping the page. As the vertical bar and protruding arm move downward together the magnet slides down the length of the metal strip at the bottom of the page until the magnet has reached the end and then disconnects by sliding further down then the page reaches. When the musician releases his foot from the pedal a spring will push the inner vertical bar back up and thus bringing the metal arm and magnet back from the left to the right.

I. This music stand will flip a sheet of music without the use of the musicians hands in an entirely mechanical process with no use of electricity.

II. This stand will flip a sheet of music by means of a mechanical foot pedal operated by the musician which will set in action a series of simple machines.
